(19) United States
(12) Patent Application Publication
(10) Pub. No.: US 2019/0249643 A1
(43) Pub. Date: Aug. 15, 2019

(54) DISPLACEMENT DEVICE FOR MACHINE POWERED GENERATOR

(71) Applicant: Ernest William Townsend, IV, Scottsdale, AZ (US)

(72) Inventor: Ernest William Townsend, IV, Scottsdale, AZ (US)

(21) Appl. No.: 15/895,092

(22) Filed: Feb. 13, 2018

(51) Int. Cl. F03B 17/04; H02K 53/00

(52) U.S. Cl. CPC F03B 17/04; G05D 9/00; H02K 53/00

(57) ABSTRACT

A machine for driving an electric generator includes a bi-level tank which simultaneously has a higher surface level and a lower surface level. In this arrangement, after a power module has been dropped from a launch point and after its engagement with the generator, the power module is returned through the bi-level tank to the launch point for another duty cycle. To do this, the operation of a displacement device inside the bi-level tank is coordinated with the operation of a valve mechanism. Specifically, the valve mechanism alternatingly provides for an entry of the power module into the tank through the lower surface level, and for a subsequent exit from the bi-level tank through the higher surface level. During this transition, the displacement device is activated to establish and maintain the respective surface levels in the bi-level tank.

### FIELD OF THE INVENTION

The present invention pertains generally to liquid filled tanks which are incorporated into machines that drive electricity generators. In particular, the present invention pertains to bi-level tanks that establish and maintain a higher surface level above a lower surface level by alternatingly exposing the respective surfaces. The present invention is particularly, but not exclusively, useful with machines having bi-level tanks that cycle power modules through the machine by buoyancy from a lower surface level to a higher surface level, for reuse of the module to generate electrical power by engaging a generator as it falls from a high launch point before it reenters the bi-level tank through the lower surface level.

### BACKGROUND OF THE INVENTION

The present invention is a machine for operating an electric power generator. A system for incorporating this machine is variously disclosed in detail in the following U.S. patent applications.
U.S. patent application Ser. No. 15/677,800, filed Aug. 15, 2017, for an invention titled “Machine Generator with Cyclical, Vertical Mass Transport Mechanism,” by Ernest William Townsend, IV, Inventor;
U.S. patent application Ser. No. 15/829,039, filed Dec. 1, 2017, for an invention titled “Control System for Machine Electric Generator,” by Ernest William Townsend, IV, Inventor; and
U.S. patent application Ser. No. 15/858,842, filed Dec. 29, 2017, for an invention titled “Power Module for Machine Power Generator,” by Ernest William Townsend, IV, Inventor.
   Disclosures in the above cited patent applications are provided here for contextual purposes and are incorporated herein by reference. With this in mind, the machine includes the following essential components.
A bi-level liquid tank which includes a transfer tank having a lower surface level and a return tank having a higher surface level. The transfer tank and the return tank are interconnected for fluid communication with each other to beneficially use the height difference between the respective surface levels for a mechanical advantage,
A valve mechanism is provided which opens and closes both an access port into the transfer tank and an underwater transfer port that is located between the transfer tank and the return tank. The access port and the transfer port are alternatingly opened and closed. Thus, when the access port is open (transfer port is closed), a module falling by gravity from a high launch point is allowed to enter the transfer tank. On the other hand, when the transfer port is open (access port is closed) the module is allowed to pass from the transfer tank and through the return tank to its launch point by buoyancy.
A displacement device which is located in the transfer tank is provided to augment the liquid volume displacement that is caused by the entry of a module into the transfer tank. Also, after the module leaves the transfer tank, the displacement device reconfigures the liquid volume in the transfer tank to prepare it for receiving the next module that is in line to enter the transfer tank.
A controller is also provided for coordinating operations of the valve mechanism and the displacement device. Importantly, control of the machine requires that the access port into the transfer tank and the transfer port between the transfer tank and the return tank are never open at the same time.

In light of the above, it is an object of the present invention to provide a displacement device for a bi-level tank which enables a machine to generate electrical power. Another object of the present invention is to provide a component for a bi-level liquid tank that functions to maintain the integrity of the liquid in the bi-level tank despite the fact there are different liquid levels for the bi-level tank. Yet another object of the present invention is to disclose embodiments for a displacement device that will operate with a valve mechanism under the direction of a controller, to maintain appropriate liquid surface levels in a bi-level tank. Still another object of the present invention is to provide a displacement device that is relatively easy to install in a bi-level tank and that is comparatively cost effective.

### SUMMARY OF THE INVENTION

In accordance with the present invention, a machine for driving an electrical generator requires a bi-level tank. The machine also requires a valve mechanism for controlling liquid levels in the bi-level tank, and it requires the coordinated control of a displacement device with the valve mechanism to operationally change liquid volumes in the bi-level tank. In combination, the bi-level tank, the valve mechanism and the displacement device provide for the transit of a power module through the bi-level tank during its machine duty cycle. In the duty cycle, after a power module has driven the electrical generator, the power module is returned through the bi-level tank to a launch point where it will begin another duty cycle. As envisioned for the present invention, the machine will simultaneously control a plurality of power modules which together, in sequence, will continuously drive the electrical generator.

Structurally, the bi-level tank includes a transfer tank which has a lower surface level, and it includes a return tank which has a higher surface level. The valve mechanism, which is mounted on the bi-level tank, controls these liquid surface levels by coordinating the opening and closing of an access port and a transfer port. For this combination, the access port is located on the transfer tank above the lower surface level. On the other hand, the transfer port is located inside the bi-level tank to separate the transfer tank from the return tank. In this arrangement, the access port and the transfer port are never open at the same time.

The displacement device mentioned above, which is mounted inside the bi-level tank below the lower surface level, is jointly controlled with the valve mechanism. To do this, the displacement device is activated in accordance with a predetermined schedule that is coordinated with the operation of the valve mechanism. As envisioned for the present invention, the displacement device can be either a pneumatic device (e.g. a bladder) or a mechanical device (e.g. a piston). In either case, the displacement device will be located inside the transfer tank. Further, for both the pneumatic and the mechanical embodiments of the present invention, it is envisioned that there may be a plurality of displacement devices located in the transfer tank.

For its pneumatic embodiment, the displacement device is preferably an inflatable bladder-type structure that can be activated either by compressed air or steam. On the other hand, the mechanical version of the displacement device will preferably be a piston-like structure that can be mechanically operated by a drive rod. Regardless of its type, an activated displacement device will need to displace a volume of liquid in the transfer tank that is equal in volume to the volume, Vₘ, of a power module.

As noted above, it is envisioned for the present invention that a displacement device may include a plurality of displacement device components. If so, for the pneumatic embodiment, within a plurality of inflatable bladders for the displacement device there needs to be an n number of inflatable bladders. In this plurality, each component bladder has a same volume V_{b} when inflated, and the combined volume of these component bladders will equal the volume Vₘ of a single module, ΣV_{b}=Vₘ. In this case, at least one auxiliary bladder will be provided which also has an inflated volume V_{b}. Thus, the auxiliary bladder can be operationally employed while another bladder is undergoing maintenance. Similarly, for the same purpose, a mechanical embodiment of the displacement device may include an n number of piston components. Each piston component will then have a same volume Vₚ when activated, and their combined activated volume will equal Vₘ, ΣVₚ=Vₘ.

For an operation of the machine of the present invention, a controller is connected to the displacement device and to the valve mechanism for moving the displacement device from a deactivated configuration with zero volume, to an activated configuration with a volume equal to Vₘ. This activation is accomplished after the module has been received into the bi-level tank and after the access port has been closed. With the transfer port now opened, a liquid pathway is established for the module to leave the transfer tank and enter the return tank. The module will then eventually emerge from return tank of the bi-level tank at the higher surface level. Subsequently, after the access port has been reopened and the transfer port has been reclosed, the displacement device is deactivated.

With the above in mind, and with reference to a single power module, an operation of the machine and the bi-level tank of the present invention may be best considered as a three phase duty cycle. In particular, consider that the transfer tank has a total liquid volume capacity Vₜₒₜₐₗ, and that the bi-level tank is sequentially reconfigured according to an operation of the valve mechanism in the three-phase duty cycle.

For the first phase of the duty cycle, which occurs before a power module enters the transfer tank, the access port is open and the transfer port is closed. In this first phase, the bi-level tank is configured to receive a module having a volume Vₘ. Specifically, at this time, Vₜₒₜₐₗ will equal the sum of a liquid volume in the transfer tank V_{liquid} and a volume of air above the lower surface level that is equal to Vₘ (i.e. Vₜₒₜₐₗ=V_{liquid}+Vₘ).

For the second phase of the duty cycle, during which the power module is being moved in the transfer tank for entry into the return tank, the access port is closed and the transfer port is open. In this second phase, the total volume capacity Vₜₒₜₐₗ of the transfer tank equals a reduced liquid volume V′_{liquid}, plus 2Vₘ. This is so because the volume 2Vₘ in the transfer tank during the second phase includes the volume Vₘ of the activated displacement device, and the volume Vₘ of the module that is being reoriented in the transfer tank (i.e. Vₜₒₜₐₗ=V′_{liquid}+2Vₘ).

For the third phase of the duty cycle, the access port has been reopened and the transfer port has been reclosed. In this third phase, the power module has already left the transfer tank, With the access port open, the displacement device can be deactivated. A consequence here is that liquid in the transfer tank recedes to create an air volume, Vₘ, above the lower surface level. Importantly, with this reconfiguration, the transfer tank is ready for another first phase. Also, Vₜₒₜₐₗ again equals the liquid volume in the transfer tank V_{liquid}, plus a volume of air above the lower surface level that is equal to Vₘ (i.e. Vₜₒₜₐₗ=V_{liquid}+Vₘ).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a general schematic presentation of a bi-level tank for the present invention with the bi-level tank incorporated into a machine for driving a power generator;

FIG. 1B shows the machine of the present invention with its three operational phases identified for purposes of disclosure;

FIG. 2A is a schematic presentation of a bi-level tank in accordance with the present invention with the bi-level tank configured for the first phase of a controlled operation wherein an access port into the bi-level tank is open and a transfer port inside the bi-level tank is closed;

FIG. 2B shows the bi-level tank of FIG. 2A during the second phase of the controlled operation wherein the access port is closed and the transfer port has been opened after the module has entered the bi-level tank, and after the displacement device has been activated;

FIG. 2C shows the bi-level tank as in FIG. 2B during the third phase of the controlled operation after the module has entered the return tank and the transfer port has been reclosed and the access port has been reopened so the displacement device can be deactivated and the bi-level tank reconfigured for the first phase;

FIG. 3 is a functional schematic presentation of the displacement device;

FIG. 4A shows a deactivated configuration for a pneumatic (bladder) displacement device;

FIG. 4B shows an activated configuration for the pneumatic (bladder) displacement device shown in FIG. 4A;

FIG. 5A shows a deactivated configuration for a mechanical (piston) displacement device;

FIG. 5B shows an activated configuration for the mechanical (piston) displacement device shown in FIG. 5A; and

FIG. 6 is a time-line chart showing power requirements and liquid volume displacement changes during the second phase of the controlled operation when configurations of a displacement device, as shown in FIGS. 4A, 4B, 5A and 5B, are made to accommodate the transfer of a module through the bi-level tank.

### DESCRIPTION OF THE PREFERRED EMBODIMENTS

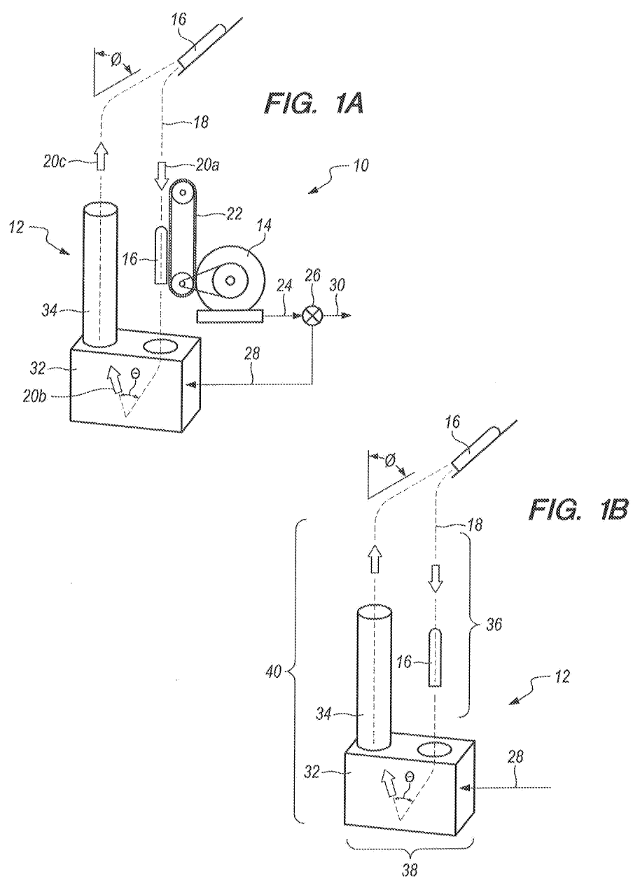

Referring initially to FIG. 1A, a system for generating electric power in accordance with the present invention is shown and is generally designated 10. As shown, the system 10 includes a bi-level tank 12 and an electric generator 14. Also shown, is a module 16 that is moved along a path 18 in a direction indicated by the arrows 20a, 20b and 20c. As intended for the system 10, during a duty cycle, the module 16 is dropped to fall along the path 18 where it engages with a drive mechanism 22 of the electric generator 14, During this engagement the kinetic energy of the falling module 16 is converted into an electric output power 24 from the electric generator 14. The output power 24 is then sent from the electric generator 14 to a summing point 26 where a portion of the output power 24 is returned to the system 10. The returned power is used as an input power 28 for operating the bi-level tank 12 and other mechanical components of the system 10. The difference between the output power 24 and the input power 28 at the summing point 26 is a commercial power 30 which is available for commercial use.

In both FIG. 1A and FIG. 1B it is shown that the bi-level tank 12 includes a transfer tank 32 and a return tank 34, With this structure in mind, an operation of the present invention can be considered as having a three phase duty cycle. Specifically, in FIG. 1B, the three phases of the duty cycle are identified as: i) a power phase 36 (i.e. a first phase) wherein the module 16 is engaged with the drive mechanism 22 of the electric generator 14 to generate the electric power output 24; ii) a transfer phase 38 (i.e. a second phase) wherein the module 16 is reoriented in the transfer tank 32; and iii) a return phase 40 (i.e. a third phase) wherein the module 16 has left the transfer tank 32 for travel through the return tank 34 to be positioned for the start of a next duty cycle.

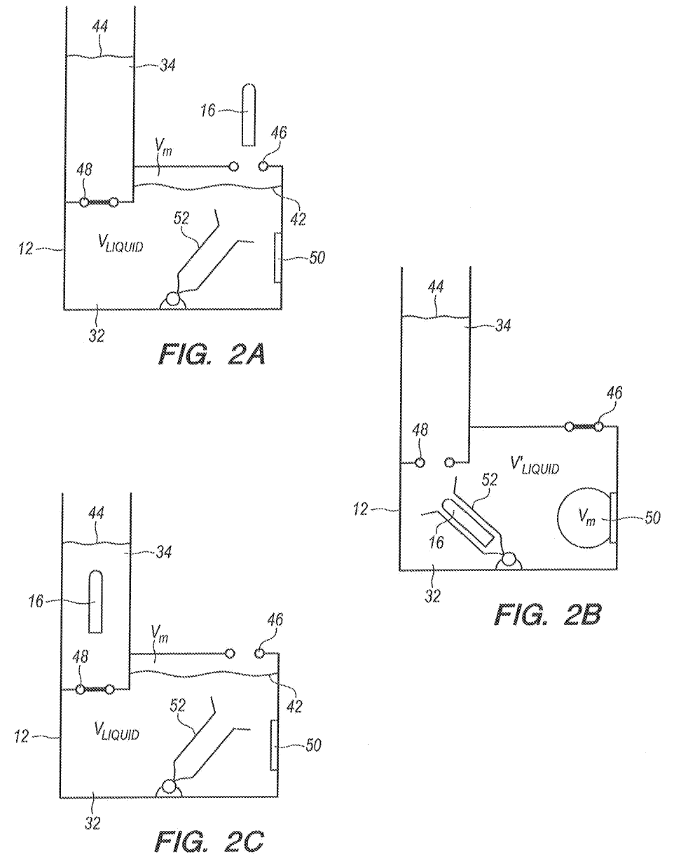

In greater detail, FIGS. 2A, 2B and 2C respectively describe the configurations of the bi-level tank 12 in each of a duty cycle's three phases. For purposes of disclosure, however, only a single module 16 is considered. Nevertheless, it is to be appreciated that the present invention envisions the simultaneous use of a plurality of modules 16 (e.g. three or more).

In FIG. 2A, a bi-level tank 12 is shown configured for the power phase 36 of a duty cycle. Several aspects of this configuration are noteworthy. For one, both the lower surface level 42 of liquid in the transfer tank 32, and the higher surface level 44 of liquid in the return tank 34 are exposed, Note: the configuration for the bi-level tank 12 wherein both surfaces 42 and 44 are exposed occurs only when the access port 46 into the transfer tank 32 is open. Importantly, the access port 46 can be open only when the transfer port 48 is closed (as indicated by the solid line in FIG. 2A). An important consequence here is that during the power phase 36 the transfer tank 32 is separated from the return tank 34, i.e. there is no liquid communication between the transfer tank 32 and the return tank 34. Another noteworthy aspect of the configuration for the bi-level tank 12 during the power phase 36 is that a volume of air is established between the lower surface level 42 and the access port 46. Importantly, the volume of this air is equal to Vin of the volume of the module 16. It is also to be noted that a displacement device 60 which is located in the transfer tank 32 is deactivated, and that a pivot unit 52 is empty and positioned to receive a module 16.

In FIG. 2B, the bi-level tank 12 is configured for the transfer phase 38 of the duty cycle. In this phase, the access port 46 is closed and the transfer port 48 is open. A noteworthy aspect of the transfer phase 38 is the fact that only the higher surface level 44 is exposed. Accordingly, with the transfer port 48 open and the access port 46 closed, the transfer tank 32 is connected in liquid communication with the return tank 34. Two other specific aspects of the transfer phase 38 are significant. For one, the volume of air Vₘ between the lower surface level 42 and the access port 46 has been replaced with liquid. Specifically, this replacement has occurred because the module 16 with a volume Vₘ entered the transfer tank 32 before the access port 46 was closed. The other significant aspect here is that the displacement device 50 has been activated to add a displacement volume equal to Vₘ in the transfer tank 32. Stated differently, a replacement volume Vₘ (module 16) and a displacement volume Vₘ (activated displacement device 50) have been added to the transfer tank 32 while the access port 46 has been closed. Further, during this transfer phase 38, the pivot unit 52 has reoriented the module 16 for its return by buoyancy through an open path 18 into the return tank 34.

To begin the return phase 40 of the duty cycle, FIG. 20 shows that the transfer port 48 is reclosed and the access port 46 is reopened. At this point, the transfer tank 32 is again separated from the return tank 34 and the module 16 with its volume Vₘ has left the transfer tank 32. Thus, as the displacement device 50 is deactivated during the return phase 40, liquid in the transfer tank 32 recedes to reestablish a volume of air Vₘ between the lower surface level 42 and the access port 46. The bi-level tank 12 is now reconfigured as it was in the power phase 36 to receive the next module 16 in the duty cycle.

From the perspective of liquid volumes in the bi-level tank 12, within each duty cycle, the three phases disclosed above with reference to FIGS. 2A-2C depend on the open/close status of the access port 46 and the transfer port 48, With this in mind, also consider that the transfer tank 32 has a total volume capacity Vₜₒₜₐₗ. For the power phase 36 of the duty cycle, before a module 16 enters the transfer tank 32, the access port 46 is open and the transfer port 48 is closed. In this configuration, the total volume Vₜₒₜₐₗ of the transfer tank 32 includes the liquid volume V_{liquid} in the transfer tank 32 and the volume of air Vₘ that is above the lower surface level 42 (Vₜₒₜₐₗ=V_{liquid}Vₘ). On the other hand, for the transfer phase 38 of the duty cycle, with the access port 46 closed and the transfer port 48 open, the total volume capacity Vₜₒₜₐₗ of the transfer tank 32 includes a reduced liquid volume V′_{liquid}, plus the volume Vₘ of the activated displacement device 50 and the volume Vₘ of the module 16 (Vₜₒₜₐₗ=V′_{liquid}+2Vₘ). In the return phase 40 of the duty cycle, after the access port 46 has been reopened and the transfer port 48 has been reclosed, the displacement device 50 is deactivated. Thus, Vₜₒₜₐₗ again equals the liquid volume V_{liquid} in the transfer tank and the volume of air above the lower surface level 42 that is equal to Vₘ(Vₜₒₜₐₗ=V_{liquid}+Vₘ).

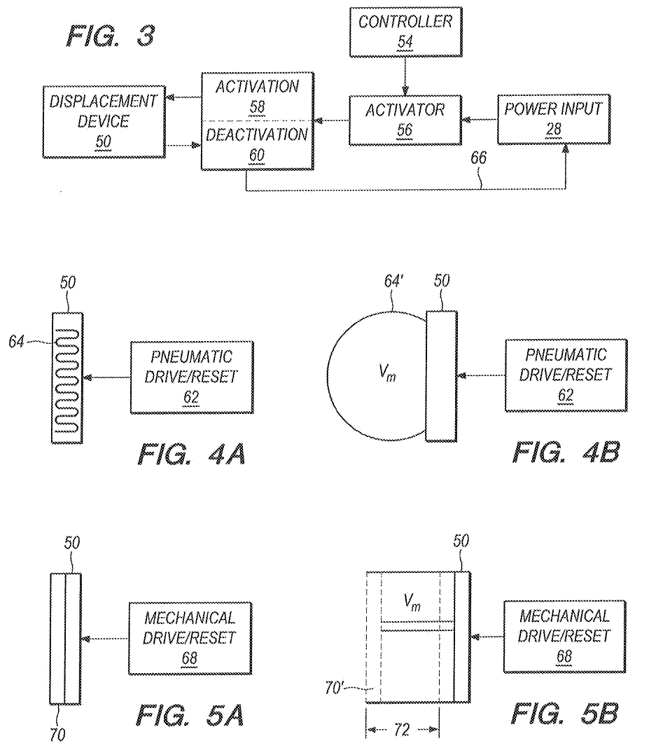

With specific reference to the displacement device 50, recall that it may have either a pneumatic embodiment or a mechanical embodiment, FIG. 3, however, indicates that the functionality and purpose for both embodiments of the displacement device 50 are substantially similar and require similar structure. For instance, in FIG. 3 it will be seen that a controller 54 is provided for the system 10 that will operate an activator 56. FIG. 3 also shows that the activator 56 is powered by input power 28 that is obtained from the electric generator 14. With these connections, the activator 56 will alternatingly operate both an activation device 58 and a deactivation device 60. Although FIG. 3 shows the activation device 58 and the deactivation device 60 to be separate devices, it is to be appreciated that the activation/deactivation functions of these devices can be performed by a single, consolidated device.

Referring now to FIGS. 4A and 48, a pneumatic embodiment for the displacement device 50 is shown. Preferably, the pneumatic displacement device 50 will include a drive/reset mechanism 62 that will inflate/deflate an inflatable member, such as a bladder 64. As disclosed above, the bladder 64 will operate between a first configuration wherein the deactivated bladder 64 is deflated with an effective volume of zero, and a second configuration wherein the activated bladder 64′ is inflated to a volume Vₘ. The timing for an inflation or deflation of the bladder 64 will be determined based on the duty cycle for a module 16 which is implemented by the controller 54.

As envisioned by the present invention, an operation of the displacement device 50 with an inflatable/deflatable bladder 64 can be accomplished with either compressed air or steam. It is further envisioned by the present invention that the deflation of a bladder 64 will be accomplished primarily by liquid pressure on the bladder 64 in the transfer tank 32, with the possible assistance of a suction capability from the deactivation device 60. In either case, the air/steam that is evacuated from the bladder 64 can be sent back via a transfer line 66 to the activator 56 (see FIG. 3) for use by the activation device 58 in a subsequent inflation of the bladder 64.

The operation for a mechanical embodiment of the displacement device 50 is disclosed with reference to FIGS. 5A and 58. In this case, the activation/deactivation mechanism 58/60 operates a drive/reset mechanism 68 that moves a structure such as a piston 70. Specifically, during a duty cycle of the module 16, the piston 70 is moved from a first configuration, wherein a zero volume of liquid in the transfer tank 32 is affected by the displacement device 50, to a second configuration wherein a volume Vₘ of liquid in the transfer tank 32 has been displaced. To do this, the piston 70 is moved through a distance 72 that is sufficient to displace a volume Vin of liquid in the transfer tank 32.

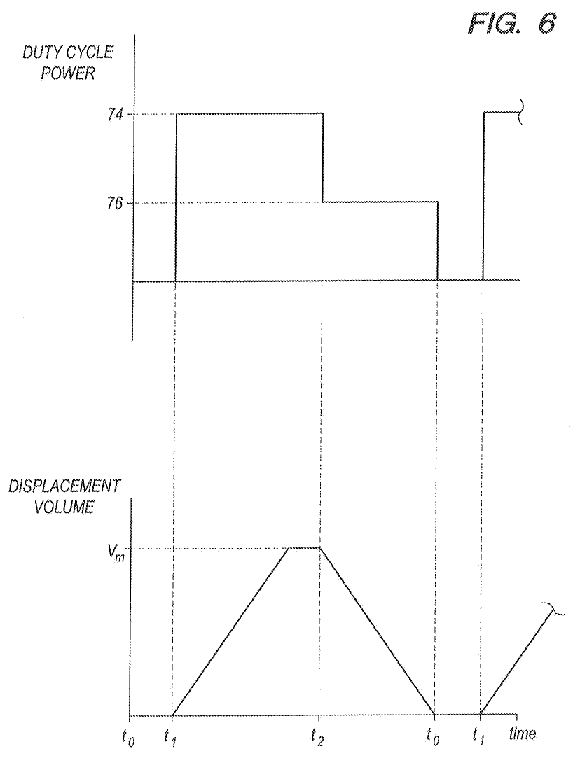

FIG. 6 shows the power requirements needed for the operation of a displacement device 50 during the transfer phase 38 of a duty cycle for a module 16. FIG. 6 also shows the contemporaneous displacement volume that is created by the displacement device 50 in the transfer tank 32 during the transfer phase 38. As shown in FIG. 6, the second phase 38 begins at a time to when the access port 46 is open and the transfer port 48 is closed.

At the beginning of the transfer phase 38, during the time interval between t₀ and t₁, the access port 46 is closed and the transfer port 48 is open. At the time t₁ the displacement device 50 is activated with a drive power 74. With the drive power 74 between t₁ and t₂ the displacement device 50 achieves and maintains a displacement volume Vₘ in the transfer tank 32. At the time t₂, however, the displacement device 50 is deactivated. As indicated above, after the time t₂, it may be necessary to apply a reset power 76 that will assist in diminishing the volume of the displacement device 50. In any event, at the time t₂ the displacement device 50 is deactivated. The displaced volume of liquid in the transfer tank 32 is then reduced to zero, at or before t₀, for a repeat of the transfer phase 38.

While the particular Displacement Device for Machine Powered Generator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A system for controlling liquid levels in a bi-level tank which comprises:
a module having a volume Vₘ;
a bi-level tank having a lower surface level and a higher surface level;
a valve mechanism including an access port located above the lower surface level and a transfer port submerged in the bi-level tank below the higher surface level, wherein the transfer port is closed when the access port is open, and the access port is closed when the transfer port is open;
a displacement device mounted inside the bi-level tank below the lower surface level;
an actuator for moving the displacement device between a first configuration wherein the displacement device has a volume equal to zero and a second configuration wherein the displacement device has a volume equal to Vₘ; and
a controller connected to the actuator and to the valve mechanism for moving the displacement device from its first configuration to its second configuration after the module has been received into the bi-level tank through the open access port and after the access port is closed, and for moving the displacement device from its second configuration to its first configuration after the module has passed through the open transfer port and after the access port has been reopened and the transfer port has been reclosed.

2. The system of claim 1 wherein the displacement device is a pneumatic mechanism.

3. The system of claim 2 wherein the pneumatic mechanism is an inflatable bladder.

4. The system of claim 2 wherein the pneumatic mechanism is a plurality of an n number of inflatable bladders, wherein each bladder has a same volume V_{b} when inflated, and wherein the plurality of inflated bladders has a combined volume ΣV_{b}=Vₘ.

5. The system of claim 4 further comprising at least one auxiliary bladder having an inflated volume V_{b}, wherein the auxiliary bladder is operationally employed while another bladder is undergoing maintenance.

6. The system of claim 1 wherein the displacement device is a mechanical mechanism.

7. The system of claim 6 wherein the mechanical mechanism is a piston.

8. The system of claim 7 wherein the mechanical mechanism includes a plurality of an n number of pistons and each piston displaces a same volume Vₚ when activated, and wherein the plurality of activated pistons has a combined activated volume ΣVₚ=Vₘ.\

9. The system of claim 8 further comprising at least one auxiliary piston having an activated volume Vₚ, wherein the auxiliary piston is operationally employed while another piston is undergoing maintenance.

10. The system of claim 1 wherein the bi-level tank includes a transfer tank having a total volume capacity Vₜₒₜₐₗ, and the bi-level tank is sequentially reconfigured in a three-phase duty cycle.

11. The system of claim 10 wherein a first phase of the three-phase duty cycle begins before the module enters the transfer tank, when the access port is open and the transfer port is closed, with the bi-level tank configured to receive the module having a volume Vₘ, and wherein Vₜₒₜₐₗ equals the sum of a liquid volume in the transfer tank V_{liquid} and a volume of air above the lower surface level equal to Vₘ(Vₜₒₜₐₗ=V_{liquid}+Vₘ).

12. The system of claim 11 wherein during a second phase of the three-phase duty cycle while the module is being moved in the transfer tank, when the access port is closed and the transfer port is open, wherein the total volume capacity Vₜₒₜₐₗ equals a reduced V′_{liquid} plus 2Vₘ (Vₜₒₜₐₗ=V′_{liquid}+2Vₘ), and wherein the volume 2Vₘ in the second phase equals the volume Vₘ of the activated displacement device in its second configuration and the volume Vₘ of the module in the transfer tank.

13. The system of claim 12 wherein during a third phase of the three-phase duty cycle, after the access port has been reopened and the transfer port has been reclosed, and after the displacement device has been deactivated to reconfigure the transfer tank for another first phase, Vₜₒₜₐₗ again equals the liquid volume in the transfer tank V_{liquid} and the volume of air above the lower surface level equal to Vₘ(Vₜₒₜₐₗ=V_{liquid}+Vₘ).

14. A method for controlling liquid levels in a bi-level tank during a three-phase duty cycle, wherein the method comprises the steps of:
providing a bi-level tank having a higher surface level and a lower surface level;
configuring the bi-level tank to receive a module of volume Vₘ during a first phase of the three-phase duty cycle, wherein an access port into the bi-level tank is open and a transfer port submerged inside the bi-level tank is closed to create a transfer tank between the access port and the transfer port, and wherein an open air volume Vₘ is established below the access port and above the lower surface level in the transfer tank for receiving the module of volume Vₘ into the transfer tank;
beginning a second phase of the three-phase duty cycle after the module of volume Vₘ has entered the transfer tank by closing the access port and opening the transfer port;
activating a displacement device in the transfer tank during the second phase to displace a volume Vₘ of liquid from the transfer tank and into a return tank as the module of volume Vₘ simultaneously exits from the transfer tank and into the return tank through the open transfer port;
beginning a third phase of the three-phase duty cycle by closing the transfer port and reopening the access port after the module of volume Vₘ has left the transfer tank; and
reconfiguring the transfer tank during the third phase by deactivating the displacement device to reestablish the open air volume Vₘ above the lower surface level in the transfer tank to continue the controlled operation.

15. The method of claim 14 wherein the transfer tank has a total volume capacity Vₜₒₜₐₗ and wherein, for the first phase of the three-phase duty cycle, Vₜₒₜₐₗ equals the sum of a liquid volume in the transfer tank V_{liquid} and a volume of air above the lower surface level equal to the open air Vₘ(Vₜₒₜₐₗ=V_{liquid}+Vₘ).

16. The method of claim 15 wherein, for the second phase of the three-phase duty cycle, the total volume capacity Vₜₒₜₐₗ of the transfer tank equals a reduced V′_{liquid} plus 2Vₘ(Vₜₒₜₐₗ=V′_{liquid}2Vₘ), and wherein the volume 2Vₘ in the second phase equals the volume Vₘ of the activated displacement device and the volume Vₘ of the module in the transfer tank.

17. The method of claim 16 wherein during the third phase of the three-phase duty cycle, after the access port has been reopened and the transfer port has been reclosed, and after the displacement device has been deactivated to reconfigure the transfer tank for another first phase, Vₜₒₜₐₗ again equals the liquid volume in the transfer tank V_{liquid} and a volume of air above the lower surface level equal to Vₘ (Vₜₒₜₐₗ=V_{liquid}+Vₘ).

18. A bi-level tank which comprises:
a lower tank having a lower surface level, wherein the lower surface level is alternately exposed and enclosed, wherein the lower surface level is enclosed when a liquid tight cover is established over the lower surface level;
an upper tank having a higher surface level, wherein the higher surface level is always exposed; and
a means for separating the upper tank from the lower tank only when the lower surface level of the lower tank is exposed, and for establishing liquid communication between the lower tank and the upper tank only when the lower surface level is enclosed by the liquid-tight cover.

19. The bi-level tank of claim 18 wherein the separating means is a valve mechanism including an access port with the liquid-tight cover located above the lower surface level and a transfer port submerged in the bi-level tank below the higher surface level, wherein the transfer port is closed when the access port is open, and the access port is closed when the transfer port is open, and wherein the bi-level tank further comprises:
a module with a volume Vₘ;
a displacement device mounted inside the bi-level tank below the lower surface level; and
an actuator for moving the displacement device between a first configuration wherein the displacement device has a volume equal to zero and a second configuration wherein the displacement device has a volume equal to Vₘ.

20. The bi-level tank of claim 19 further comprising a controller connected to the actuator and to the valve mechanism for moving the displacement device from its first configuration to its second configuration after the module has been received into the bi-level tank through the open access port and after the access port is closed, and for moving the displacement device from its second configuration to its first configuration after the module has passed through the open transfer port and after the access port has been reopened and the transfer port has been reclosed.
